(19) United States
(12) Patent Application Publication
(10) Pub. No.: US 2007/0145794 A1
(43) Pub. Date: Jun. 28, 2007

(54) Seat post for a bicycle

(75) Inventors: Giuseppe Dal Pra', Zane (Vicenza) (IT); Mario Meggiolan, Creazzo (Vicenza) (IT)

Correspondence Address: VOLPE AND KOENIG, P.C., UNITED PLAZA, SUITE 1600, 30 SOUTH 17TH STREET, PHILADELPHIA, PA, 19103, US

(73) Assignee: Campagnolo S.r.l., Vicenza (IT)

(21) Appl. No.: 11/639,481

(22) Filed: Dec. 14, 2006

Related U.S. Application Data
(63) Continuation of application No. PCT/IT05/00736, filed on Dec. 14, 2005.

(51) Int. Cl. B62J 1/00

(52) U.S. Cl. 297/195.1

(57) ABSTRACT

A seat post for a bicycle includes a tubular element that supports a seat of a bicycle and grasping element of a portion of a frame of the seat. The grasping elements are adapted to be coupled to the tubular element and to be selectively activated/deactivated to prevent/allow a translation movement of the seat with respect to the tubular element along a predetermined direction. The grasping elements include abutment elements and can be coupled with the tubular element in operative coupling configurations in which the abutment elements define translation limit positions of the seat with respect to the tubular element in predetermined directions. Abutment elements may be defined on a jaw in asymmetric positions with respect to each other.

### CROSS REFERENCE TO RELATED APPLICATION(S)

This application is a continuation of PCT/IT2005/000736, filed Dec. 14, 2005, which is incorporated by reference as if fully set forth.

### FIELD OF INVENTION

The present invention relates to a seat post for a bicycle. In particular, the invention relates to an adjustable seat post for a racing bicycle.

### BACKGROUND

Throughout the present description and the subsequent claims, the expression “seat post for a bicycle” is used to indicate that component of a bicycle that supports the seat on the bicycle frame. In particular, “adjustable seat post” is used to indicate a seat post that allows the position of the seat to be adjusted with respect to the bicycle pedals.

In the field of bicycles, above all racing bicycles, the use of adjustable seat posts is widespread. The ideal position of the seat is that which allows the most advanced leg of the cyclist to bend to 90° when the pedals are aligned horizontally.

Of course, the ideal position of the seat depends upon the physiology of the cyclist, in particular the length of his legs. Such an ideal position can be obtained by moving the seat vertically and with respect to a vertical reference plane passing through the axis of the bottom bracket of the bicycle.

Most of the known seat posts comprise a tubular element adapted to be telescopically inserted, for at least part of the longitudinal extension thereof, in the appropriate tubular seat provided in the bicycle frame and a pair of jaws adapted to grasp the rectilinear portions of the rods of the seat frame to associate the seat with the tubular element.

The height adjustment of the seat is obtained by sliding the tubular element up and down in the appropriate tubular seat of the frame; in particular, the stable positioning of the seat at the desired height is obtained by clamping appropriate clamping members provided on the tubular seat of the bicycle frame onto the tubular element.

The adjustment of the seat with respect to the vertical reference plane passing through the axis of the bottom bracket of the bicycle, on the other hand, is obtained by sliding the rectilinear portion of the rods of the frame of the seat with respect to the jaws; in particular, the stable positioning of the seat at the desired distance from the vertical reference plane passing through the axis of the bottom bracket of the bicycle is obtained by clamping the aforementioned jaws on the rods.

In conventional seat posts of the type described above, the positioning limits of the seat with respect to the vertical reference plane passing through the axis of the bottom bracket of the bicycle are defined by the edges of the jaws, against which the bending points of the rods that define the rectilinear portions grasped by the jaws abut, respectively, in the two directions of translation.

Generally, in order to be able to obtain optimal positioning of the seat for cyclists of all sizes, seats and seat posts are sold in different sizes.

Throughout the present description, the expression “horizontal direction,” when referred to the adjustment of the position of the seat, is used to indicate the adjustment of the position of the seat with respect to the vertical reference plane passing through the axis of the bottom bracket of the bicycle, such adjustment being carried out in a predetermined direction that can be perfectly horizontal (i.e. perfectly perpendicular to the aforementioned reference plane) or, preferably, inclined downwards with respect to the horizontal direction by a certain angle, so that the seat always maintains an angular position inclined downwards.

### SUMMARY

The present invention therefore relates to a seat post for a bicycle comprising a tubular element adapted to support a seat of a bicycle, and grasping means of a frame portion of the seat. The grasping means is adapted to be coupled to the tubular element and to be selectively activated/deactivated to prevent/allow a translation movement of the seat with respect to the tubular element along a predetermined direction. The grasping means comprises at least one first abutment element and is adapted to be coupled to the tubular element in a first operative coupling configuration in which the at least one first abutment element defines a first translation limit position of the seat with respect to the tubular element in a first way of the predetermined direction. The grasping means comprises at least one second abutment element that defines at least one second translation limit position of the seat with respect to the tubular element in the first way of the predetermined direction. The at least one second translation limit position is translated with respect to the first translation limit position along the first way of the predetermined direction.

### BRIEF DESCRIPTION OF THE DRAWING(S)

Further characteristics and advantages of the present invention shall become clearer from the following detailed description of some preferred embodiments thereof, made as a non-limiting example with reference to the attached drawings. In such drawings:

FIG. 1 is a schematic side view of a bicycle that comprises a seat post in accordance with the present invention;

FIG. 2 is a schematic view of a first embodiment of the seat post of the present invention coupled with a seat;

FIG. 3 is an exploded view of the seat post of FIG. 2;

FIG. 4 is a top view of the seat post of FIG. 2 in an assembled configuration without the seat;

FIG. 5 is a bottom view of a component of the seat post of FIG. 2;

FIG. 6a is a section in plane II of FIG. 4 of the seat post of FIG. 2 in a first operative angular positioning configuration;

FIG. 6b is a section in plane II of FIG. 4 of the seat post of FIG. 2 in a second operative angular positioning configuration;

FIG. 7a schematically shows the seat post of FIG. 2 in a first operative coupling configuration to the seat and in a first end stroke position in a first way of the horizontal direction;

FIG. 7b schematically shows the seat post of FIG. 2 in a second operative coupling configuration to the seat and in a second end stroke position in the aforementioned first way of the horizontal direction;

FIG. 8a schematically shows the seat post of FIG. 2 in the first operative coupling configuration and in a first end stroke position in a second way of the horizontal direction opposite the aforementioned first way;

FIG. 8b schematically shows the seat post of FIG. 2 in the second operative coupling configuration and in a second end stroke position in the aforementioned second way;

FIG. 9a schematically shows the seat post of FIG. 2 in the operative coupling configuration of FIG. 8a and in the operative angular positioning configuration of FIG. 6a;

FIG. 9b schematically shows the seat post of FIG. 2 in the operative coupling configuration of FIG. 8b and in the operative angular positioning configuration of FIG. 6a;

FIG. 10a is a schematic view of a second embodiment of the seat post of the present invention in a first operative coupling configuration to the seat and in a first end stroke position in the aforementioned second way of the horizontal direction;

FIG. 10b is a schematic view of the seat post of FIG. 10a in a second operative coupling configuration to the seat and in a second end stroke position in the aforementioned second way of the horizontal direction;

FIG. 11a is a schematic view of a third embodiment of the seat post of the present invention in a first operative coupling configuration to the seat and in a first end stroke position in the aforementioned second way of the horizontal direction;

FIG. 11b is a schematic view of the seat post of FIG. 11a in a second operative coupling configuration to the seat and in a second end stroke position in the aforementioned second way of the horizontal direction;

FIG. 12a is a schematic view of a fourth embodiment of the seat post of the present invention in a first operative coupling configuration to the seat and in a first end stroke position in the aforementioned second way of the horizontal direction;

FIG. 12b is a schematic view of the seat post of FIG. 12a in a second operative coupling configuration to the seat and in a second end stroke position in the aforementioned second way of the horizontal direction;

FIG. 13 is a longitudinal section of a fifth embodiment of the seat post of the present invention;

FIG. 14 is a longitudinal section of a sixth embodiment of the seat post of the present invention;

FIG. 15 is a longitudinal section of an embodiment of a first component of the seat post of FIG. 2; and

FIG. 16 is a schematic top view of an alternative embodiment of a second component of the seat post of the present invention.

### DETAILED DESCRIPTION OF THE PREFERRED EMBODIMENT(S)

Introduction

Advantageously, the seat post described herein allows obtaining extreme positioning limits of the seat in the horizontal direction wider than those that can be obtained with conventional seat posts, without needing to replace any components and at the same time keeping a large grasping zone of the seat so as to ensure high reliability of the grasp. Indeed, with conventional seat posts, once the seat has been selected, the widening of the adjustment stroke in the horizontal direction beyond the translation limits defined by a specific seat post can only be obtained by replacing the seat post with another one having shorter grasping members in the horizontal translation direction of the seat, with a consequent reduction of the grasping zone of the seat. Differently and advantageously, the seat post allows the adjustment stroke to be widened in at least one way of the horizontal direction by simply changing the operative coupling configuration of the grasping means. In other words, the seat post of the present invention makes it possible to pass from a first operative coupling configuration that ensures a first adjustment stroke in at least one first way of the horizontal direction to a different operative coupling configuration that ensures an additional adjustment stroke in the aforementioned way.

In a first embodiment of the seat post of the present invention, the at least one first abutment element can be removably associated with the at least one second abutment element. For example, the at least one first abutment element can be associated by a joint with the at least one second abutment element.

Advantageously, in such an embodiment the first abutment element can be removed from the grasping means so that they provide for the abutment a second abutment element positioned at a distance from the tubular element shorter than that of the first abutment element, thus obtaining an additional adjustment stroke. More preferably, the second element can also be removed from the grasping means so that they provide for the abutment a third abutment element positioned at a distance from the tubular element shorter than that of the second abutment element, thus obtaining a further additional adjustment stroke. Obviously, it is possible to foresee further steps of removing abutment elements to obtain further additional adjustment strokes.

In a preferred embodiment of the seat post, the at least one first abutment element is made integrally with the at least one second abutment element and the at least one second abutment element defines the at least one second translation limit position of the seat in at least one second operative coupling configuration of the grasping means with the tubular element. Advantageously, in such an embodiment the passage from the first operative coupling configuration to a different operative coupling configuration is carried out by simply moving the first abutment element to a different position so as to provide for a different abutment element into the abutment position, the different abutment element ensuring an additional adjustment stroke with respect to that which can be obtained through the first abutment element. Obviously, it is possible to foresee further steps of moving the abutment elements to obtain further additional adjustment strokes.

In the aforementioned preferred embodiment of the seat post, preferably, when the grasping means are in the first operative coupling configuration, the at least one second abutment element defines a translation limit position of the seat with respect to the tubular element in a second way of the predetermined direction opposite the first way. Advantageously, in this case the translation limits in the two opposite ways of the horizontal direction are defined by the same abutment element. It is therefore possible to obtain additional adjustment strokes both in a first way of the horizontal direction and in the opposite way by simply moving the second abutment element by 180°. More advantageously, the use of the same abutment element to obtain the additional adjustment strokes in the two opposite ways of the horizontal direction allows the grasping zone to be extended at the side opposite where such an abutment element is located, for example, as shall be described more clearly hereafter, by providing an asymmetrical shape with respect to a coupling portion of the grasping means with the tubular element. In this way an excellent compromise is achieved between reduction of the weight of the component (requirement always sought after in the field of racing bicycles) and reliability of the grasp of the seat.

Preferably, the grasping means comprise a coupling portion with the tubular element, and at least one grasping portion to the seat portion extending cantilevered asymmetrically from, and substantially perpendicular to, the coupling portion, in which the at least one first abutment element is defined by a first end surface of the at least one grasping portion.

In a first example of an embodiment, the at least one grasping portion extends cantilevered only from one side of the coupling portion and the at least one second abutment element is defined on the coupling portion on the opposite side to that from which the at least one grasping portion extends.

In a preferred example of an embodiment, the at least one grasping portion extends cantilevered asymmetrically from opposite sides of the coupling portion and the at least one second abutment element is defined by at least one second end surface of the at least one grasping portion arranged on the opposite side to the first end surface with respect to the coupling portion.

Preferably, the at least one second abutment surface is arranged, with respect to the coupling portion, at a shorter distance away than the distance between the first abutment surface and the coupling portion.

Advantageously, in both of the examples of embodiments discussed above, the asymmetry of the grasping portion allows the aforementioned additional adjustment stroke to be obtained in both of the ways of the horizontal direction (provided suitable positioning of the second abutment surface at the side at which one wishes to obtain the additional adjustment stroke). More advantageously, in the example embodiment in which the grasping portion extends cantilevered asymmetrically from opposite sides of the coupling portion, it is possible to obtain a widening of the grasping portion at the side opposite the one where the second abutment element is situated and a uniform distribution of the stress due to the weight of the cyclist on the two opposite sides of the coupling portion, thus avoiding the occurrence of a bending stress with respect to the tubular element. This allows the components of the seat post to be made from a lighter material.

In the preferred embodiment of the seat post, the grasping means comprise a pair of jaws that can be coupled together through clamping means, the at least one first and at least one second abutment element being defined in an upper jaw of the pair of jaws. Advantageously, the clamping means can be activated to clamp the jaws on the rods of the seat frame and simultaneously locking them in the desired position along the horizontal adjustment direction.

Preferably, the jaws of the pair of jaws can be rotatably associated with the tubular element with respect to an axis perpendicular to a plane of longitudinal symmetry of the frame of the bicycle. Advantageously, the clamping means can also be activated to lock the jaws on the rods of the frame in a plurality of predetermined angular positions with respect to the tubular element.

Preferably, the grasping means can be positioned in both of the configurations defining the translation limits of the seat in at least two of the predetermined angular positions, more preferably in all of the aforementioned predetermined angular positions. In such a way the angular adjustment of the seat does not influence its adjustment in the horizontal direction.

Preferably, the coupling portion of the grasping means is defined in a central body portion of both of the jaws of the pair of jaws.

More preferably, the central body portion comprises a cylindrical surface portion extending along a respective longitudinal axis.

Even more preferably, the at least one grasping portion comprises a first pair of grasping surfaces of the seat portion, the grasping surfaces of the first pair of grasping surfaces extending parallel to each other at opposite free ends of the central body portion of a first jaw of the pair of jaws, and a second pair of grasping surfaces of the seat portion, the grasping surfaces of the second pair of grasping surfaces extending parallel to each other at opposite free ends of the central body portion of a second jaw of the pair of jaws.

Advantageously, in the jaws of the seat post, the coupling zone with the tubular element and the grasping zone to the rods of the seat frame are functionally distinct from each other, and can thus be shaped and sized independently of each other so that each one carries out its function optimally.

Preferably, the first and at least one second abutment surface are defined in an upper jaw of the pair of jaws (in particular, in the jaw that in use acts as an upper jaw), at opposite front end surfaces of the grasping surfaces.

In an embodiment of the seat post, the jaws of the pair of jaws are specular, or mirror images. This allows the two jaws to be freely exchanged or be rotated in a mirror-like manner with respect to the planes of symmetry of the respective coupling portions.

However, Applicant has observed that the lower jaw and the upper jaw actually carry out at least in part different functions. The upper jaw, indeed, cooperating with the lower jaw , ensures that the rods of the seat frame are gripped and defines the translation limit positions in the horizontal direction. The lower jaw, on the other hand, as well as contributing to the grasping of the rods of the seat frame, directly receives the weight of the cyclist and transmits it to the tubular element. Applicant has therefore discovered that the jaws of the pair of jaws of the seat post can be of a different shape and be positioned independently from each other, so that each one carries out its intended function optimally.

In the seat post of the present invention, therefore, the first and at least one second abutment surface are preferably defined in the first jaw of the pair of jaws and the grasping surfaces of the first pair of grasping surfaces extend asymmetrically with respect to the longitudinal axis for a first predetermined length portion. Advantageously, the asymmetry of such a jaw ensures, as well as obtaining the additional adjustment strokes discussed above, a good extension and distribution of the grasping surface of the rods of the seat frame.

More preferably, in the seat post of the present invention, a jaw (adapted to act in operation as an upper jaw) has a grasping zone that is asymmetric with respect to the plane of symmetry of the respective coupling portion and the other jaw (adapted to act in operation as a lower jaw) has a grasping zone to the rods of the seat frame larger than that of the upper jaw. As a matter of fact, it is advantageous to make the lower jaw stronger and with a contact zone with the rods of the seat frame larger than the upper jaw; the lower jaw must, indeed, bear the weight of the cyclist and transmit it to the frame of the bicycle.

In a first preferred embodiment of the seat post, the grasping surfaces of the second pair of grasping surfaces extend on the second jaw symmetrically with respect to the longitudinal axis for a second portion of length greater than the first portion of predetermined length.

In a second preferred embodiment of the seat post, the grasping surfaces of the second pair of grasping surfaces extend on the second jaw asymmetrically with respect to the longitudinal axis for a second portion of length greater than the first portion of predetermined length.

In all of the embodiments discussed above, the jaws can be configured so that the first and at least one second abutment element are defined by curved surfaces having a concavity facing outwards. Such a provision allows a further additional adjustment stroke to be obtained, in addition to the one obtained with the asymmetry of the upper jaw.

In all of the embodiments discussed above, the tubular element preferably comprises a first rectilinear body portion adapted to be, at least in part, telescopically inserted in a tubular housing seat formed in the frame of the bicycle and a second body portion that is inclined with respect to the first body portion, the second body portion comprising a coupling free end to the grasping means.

Preferably, the second body portion of the tubular element comprises, at the free coupling end, a first flange made integrally with the second body portion and comprising a housing seat of the coupling portion of the grasping means.

More preferably, the first flange comprises, at opposite sides to the housing seat, a pair of tabs extending cantilevered from the housing seat and defining angular limit positions of the grasping means.

Even more preferably, the tabs of the pair of tabs are arranged at different heights.

In particular, in operation the inclined portion of the tubular element is advantageously intended to face the back of the bicycle, so as to keep the seat away from the handlebars. In such a position, the most advanced tab is advantageously arranged at a lower height than the other. In this way it is ensured that the seat can always maintain an angular position sloping forwards, a position that is particularly preferred by cyclists.

Preferably, the clamping means comprise a pair of screws and respective nuts, the screws being adapted to pass in respective through holes formed on the first flange at the tabs and in respective slots formed on the grasping means on opposite sides to the coupling portion to fix in position the grasping means with respect to the tubular element. Advantageously, in the adjustment step the holes keep the screws in position fixed with respect to the tubular element along the horizontal direction, whereas the slots allow the displacement in rotation of the grasping means. Therefore, there is no risk that the operator, when adjusting the angular position of the seat, involuntarily modifies its position in the horizontal direction.

In any case, embodiments of the seat post are foreseen in which, instead of the aforementioned through holes, slots are formed on the first flange.

Preferably, the grasping means comprise a second flange adapted to be coupled to the first flange through the clamping means, in which the slots are formed in the second flange.

In a preferred embodiment of the seat post, the second flange is made in a distinct piece from the jaws of the pair of jaws.

In this embodiment, preferably, at least one jaw of the pair of jaws comprises means for pulling the second flange into rotation. Such means can be defined by knurled surfaces at the outer surface of the coupling portion of the upper jaw and at the inner surface of the second flange, or, preferably, by a small tooth made on the inner surface of the second flange and a respective coupling hole made on the coupling portion of the upper jaw (or of both jaws).

In a variant embodiment, the second flange is made in a single piece with a jaw of the pair of jaws.

Preferably, the tubular element of the seat post has, for at least part of the longitudinal extension thereof, an asymmetric cross section, with a portion of the section having increased thickness. In particular, at the part of the tubular element with asymmetrical cross sections, the greater thickness is provided on the side intended to face towards the back of the bicycle.

More preferably, the asymmetric cross section entirely involves the second body portion and partially the first body portion for a first part adjacent to the second body portion. Indeed, these are the zones of maximum stress of the tubular element; these zones are thus strengthened, whereas the other zones of the tubular element that are unloaded are lightened to keep the overall weight of the component as low as possible.

Alternatively, the tubular element has a symmetrical cross section along its entire longitudinal extension. Preferably, a first portion of the first body portion of the tubular element adjacent to the second body portion has increased thickness.

In this case, preferably, the tubular element has a zone of increased thickness at a first part of the first body portion adjacent to the second body portion. In this case the most stressed portion of the tubular element is strengthened, whereas the weight of the other unloaded portions inside and outside the frame of the bicycle is kept low.

Preferably, the tubular element is made from a light metal alloy. Alternatively, the tubular element can be made from composite material. In any case, an optimal compromise between structural strength and lightness is obtained.

Preferably, the jaws are made from the same material from which the tubular element is made.

In the embodiment in which the jaws are made in distinct pieces from the second flange, the jaws can, for example, be made from composite material and the second flange from metal alloy. Preferably, the tubular element is made from carbon fibre and the second flange and the jaws from light metal alloy. It is, however, possible to foresee further combinations of different materials for tubular element, jaws and possibly second flange.

### DETAILED DESCRIPTION

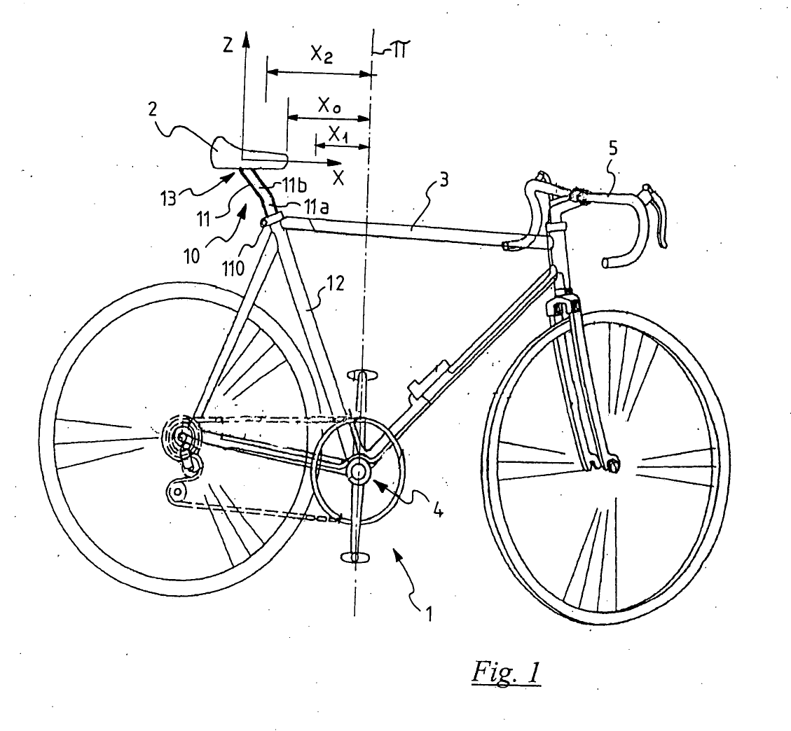

In FIG. 1, a bicycle, in particular a racing bicycle, is indicated with 1. Such a bicycle 1 comprises a seat 2 associated with a frame 3 of the bicycle 1 through a seat post 10. The bicycle 1 also comprises a bottom bracket 4 and handlebars 5, both of the conventional type.

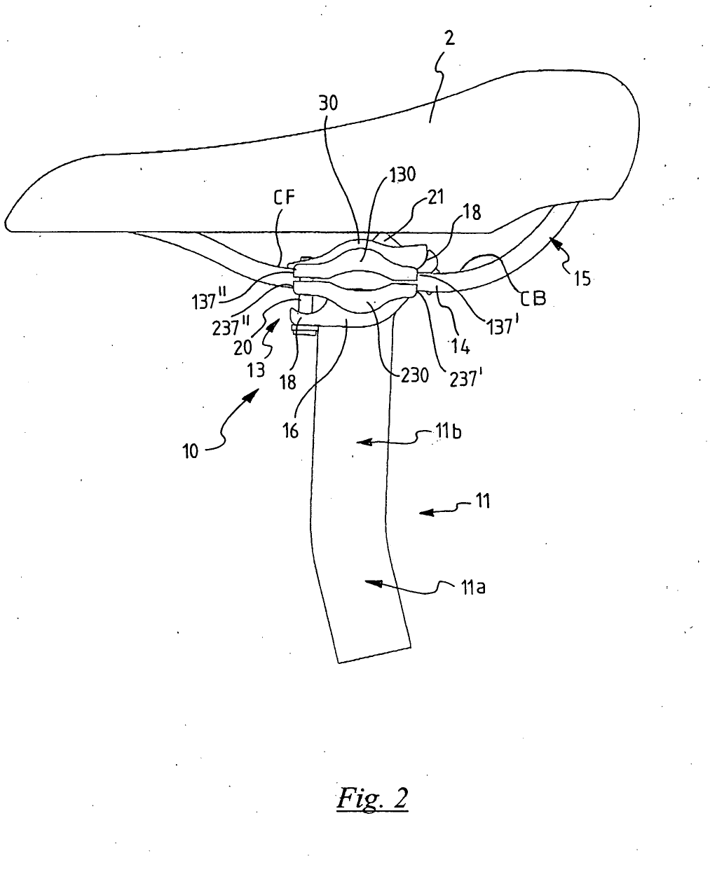

FIG. 2 shows the seat post 10 comprises a tubular element 11 adapted to be inserted telescopically, for at least part of the longitudinal extension thereof, in an appropriate tubular seat 12 provided in the frame 3 of the bicycle 1 (FIG. 1) and a pair of jaws 13 intended to be integral with the tubular element 11 and adapted to grasp the seat 2 to associate it with the tubular element 11. In particular, the jaws 13 grasp rectilinear portions 14 of the rods 15 of the frame of the seat 2. Typically, the frame of the seat 2 comprises two rods 15 disposed side-by-side and the rectilinear portion 14 of each rod 15 is delimited by a front bending point CF and a back bending point CB.

The seat post 10 is an adjustable seat post. It thus allows the adjustment of the position of the seat 2 in height (in the two ways of the direction z in FIG. 1) and in a horizontal direction (in the two ways of the direction x in FIG. 1) substantially perpendicular to a vertical reference plane π passing through the axis of the bottom bracket 4 of the bicycle 1.

The adjustment of the position of the seat 2 in height takes place in a totally conventional manner. It is obtained, in particular, by sliding the tubular element 11 up and down in the suitable tubular seat 12 of the frame 3. Once the seat 2 has been positioned at the desired height, the tubular element 11 is locked with respect to the frame 3 by clamping onto the tubular element 11 suitable jaws 110 (FIG. 1) appropriately provided on the tubular seat 12 of the frame 3.

The adjustment of the seat 2 in a horizontal direction with respect to the plane π is, on the other hand, obtained by sliding the rectilinear portion 14 of the rods 15 of the seat 2 with respect to the jaws 13. Once the seat 2 has been positioned at the desired distance x, the seat 2 is locked in position clamping the jaws 13 on the rods 15.

As already stated previously, in this description, when we speak of the adjustment of the position of the seat with respect to the plane π, we shall always refer to the adjustment along the horizontal direction x shown in FIG. 1, meaning by the expression “horizontal direction” not only a perfectly horizontal direction, but also a direction inclined with respect to the direction x by a predetermined angle so that the seat 2 always maintains an angular position inclined downwards.

In FIG. 1, the seat 2 is arranged so that its front end is at a distance x0 from the plane π. The extreme positioning limits of the seat 2 in its translation stroke along the direction x are indicated with x1 and x2: x1 is the distance from the plane π at which the seat 2 is situated in its extreme horizontal advanced position, whereas x2 is the distance from the plane π at which the seat 2 is situated in its extreme horizontal withdrawn position. The seat 2 can thus be positioned with respect to the plane π at any distance x within the range between x1 and x2.

With reference to the embodiment of the seat post 10 of the present invention illustrated in FIGS. 2-5, 6a, 6b, 7a, 7b, 8a, 8b, 9a, 9b, the pair of jaws 13 comprises, in particular, an upper jaw 130 and a lower jaw 230. The upper jaw 130 is adapted to cooperate with the lower jaw to clamp the seat 2 on the tubular element 11. The clamping takes place through a pair of screws 20, 21 and respective cylindrical nuts 22, 23.

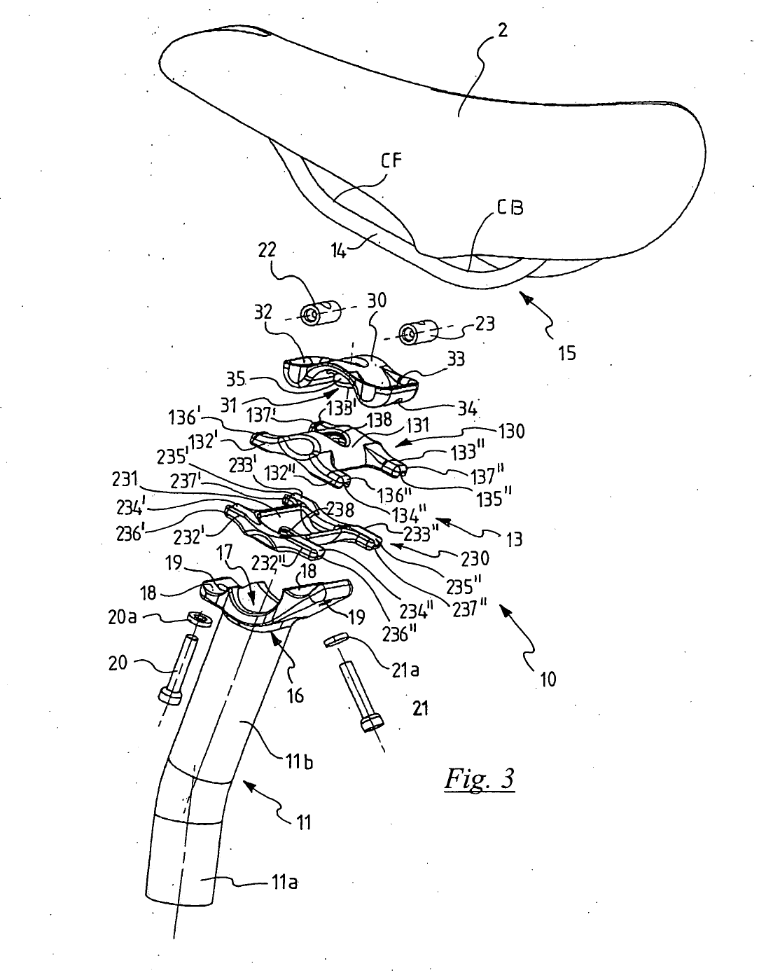

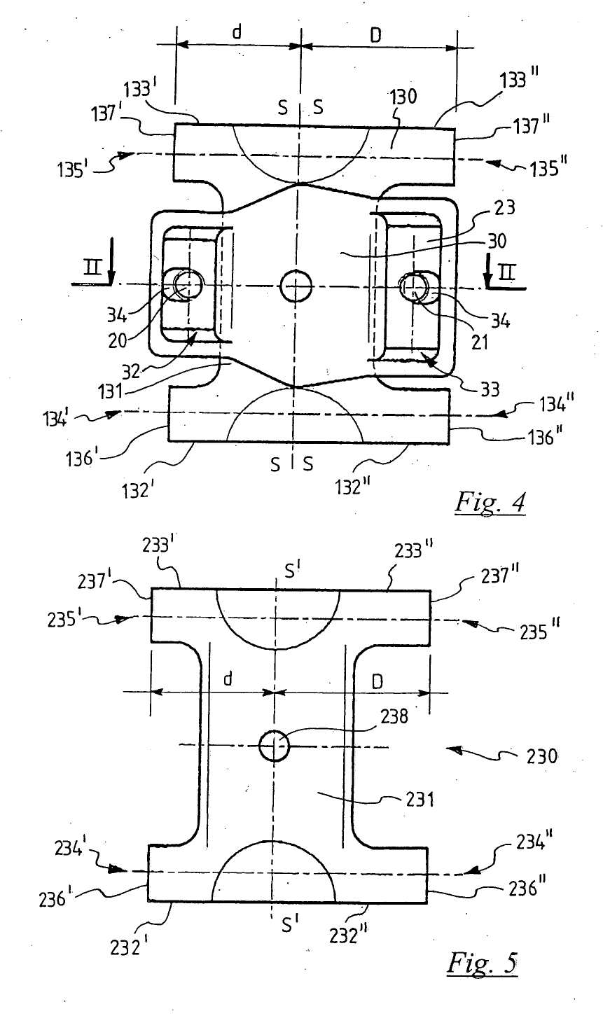

As illustrated in particular in FIG. 3, the upper jaw 130 comprises a substantially semicylindrical central body portion 131, a first pair of grasping portions 132′, 132″ of a rod 15 of the seat 2 and a second pair of grasping portions 133′, 133″ of the other rod 15 of the seat 2. The central body portion 131 extends along a respective longitudinal axis S-S (shown in FIG. 4). The grasping portions 132′, 132″ extend cantilevered at a first free end of the central body portion 131 at opposite sides to the longitudinal axis S-S of the central body portion 131 and in a direction substantially perpendicular to such an axis. Similarly, the grasping portions 133′, 133″ extend cantilevered at a second free end, opposite the first free end, of the central body portion 131 at opposite sides to the longitudinal axis S-S of the central body portion 131 and in a direction substantially perpendicular to such an axis. Grooves 134′, 134″, 135′, 135″ for housing the rectilinear portions 14 of the rods 15 of the frame of the seat 2 are formed on the grasping portions 132′, 132″, 133′, 133″ (in FIG. 3 just the grooves 134″ and 135″ can be seen, in FIGS. 4 and 5 the longitudinal axis of such grooves is shown).

Similarly, the lower jaw 230 comprises a substantially semicylindrical central body portion 231, a first pair of grasping portions 232′, 232″ of a rod 15 of the seat 2 and a second pair of grasping portions 233′, 233″ of the other rod 15 of the seat 2. The central body portion 231 extends along a respective longitudinal axis S′-S′ (represented in FIG. 5). The grasping portions 232′, 232″ extend cantilevered at a first free end of the central body portion 231 at opposite sides to the longitudinal axis S′-S′ of the central body portion 231 and in a direction substantially perpendicular to such an axis. Similarly, the grasping portions 233′, 233″ extend cantilevered at a second free end, opposite the first free end, of the central body portion 231 at opposite sides to the longitudinal axis S′-S′ of the central body portion 231 and in a direction substantially perpendicular to such an axis. Grooves 234′, 234″, 235′, 235″ for housing the rectilinear portion 14 of the rods 15 of the frame of the seat 2 are formed on the grasping portions 232′, 232″, 233′, 233″.

The size of the grooves 134′, 134″, 135′, 135″ of the grasping portions 132′, 132″, 133′, 133″ of the upper jaw 130 and the size of the grooves 234′, 234″, 235′, 235″ of the grasping portions 232′, 232″, 233′, 233″ of the lower jaw 230 are such that each of such grooves partially houses a portion of a rod 15 of the frame of the seat 2. When the jaws 130, 230 face one another and are clamped against each other, the rods 15 of the frame of the seat 2 are arranged between the grooves 134′, 134″, 135′, 135″ of the upper jaw 130 and the grooves 234′, 234″, 235′, 235″ of the lower jaw 230.

As shown for example in FIG. 2, the tubular element 11 comprises a first rectilinear body portion 11a adapted to be, at least in part, inserted in the tubular housing seat 12 formed in the frame 3 of the bicycle 1 and a second body portion 11b inclined with respect to the first body portion 11a, the second body portion 11b being intended to remain outside the tubular seat 12.

In operation, the second portion 11b of the tubular element 11 is intended to face towards the back of the bicycle 1, so as to keep the seat 2 away from the handlebars 5 (see FIG. 1).

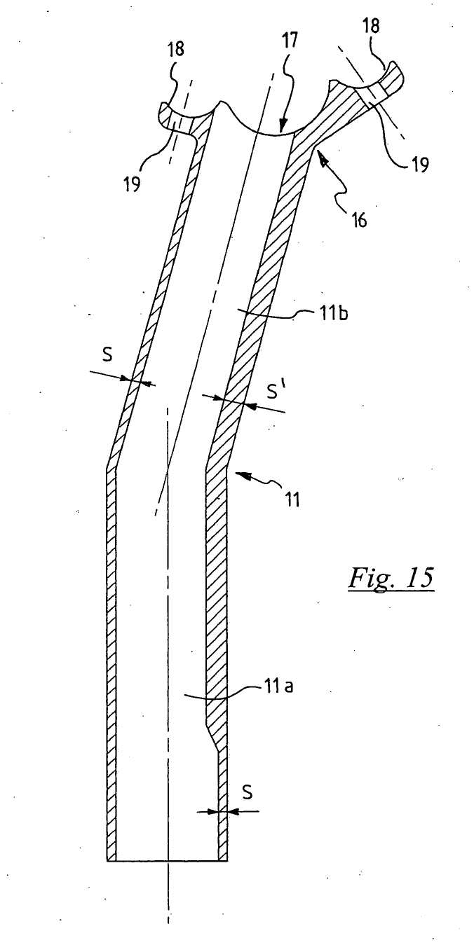

With reference once again to FIG. 3, the second body portion 11b of the tubular element 11 comprises a coupling free end to the seat 2 on which a flange 16 is integrally formed. As better illustrated in FIG. 15, such a flange 16 in turn comprises a housing seat 17 for the central body portion 231 of the lower jaw 230 and, at opposite sides to the housing seat 17, a pair of tabs 18 extending cantilevered from the housing seat 17 and adapted to act as stop surfaces of the angular rotation of the jaws 130, 230 about an axis parallel to the longitudinal axes S-S and S′-S′ of the respective central body portions 131, 231, as shall be described more clearly below.

The housing seat 17 of the lower jaw 230 is defined by a cylindrical surface portion having a shape matching that of the central body portion 131, 231 of the jaws 130, 230. In particular, the housing seat 17 and the central body portion 131, 231 of the jaws 130, 230 have the same diameter. The seat 17 and the central body portion 231 of the lower jaw 230 are adapted to be coupled together in abutment.

Also, the tabs 18 are defined by a cylindrical surface portion and are arranged at different heights with respect to the end portion of the tubular element 11 on which the flange 16 is formed. In particular, when the tubular element 11 is mounted on the frame 3 of the bicycle, the tab 18 closest to the handlebars 5 is at a lower height than the other tab 18; this ensures that the seat 2 takes up a position sloping forwards, such a position being particularly preferred by cyclists.

On each tab 18 a cylindrical through hole 19 (or a slot) is formed in which a respective clamping screw 20, 21 is inserted. In the clamping step, the heads of the clamping screws 20, 21 stop by abutment on the lower surfaces of the tabs 18 through interposition of suitable washers 20a, 21a.

The seat post 10 also comprises a second flange 30 adapted to cooperate with the flange 16 of the tubular element 11 to clamp the jaws 130 and 230. For such a purpose, the flange 30 is coupled on the top thereof with the upper jaw 130 and comprises, on the lower surface thereof, a central housing seat 31 for the central body portion 131 of the upper jaw 130 and, on the upper surface thereof, a pair of side seats 32, 33 extending from opposite sides to the seat 31 and adapted to house the nuts 22, 23 in the clamping step.

The housing seat 31 of the upper jaw 130 is defined by a cylindrical surface portion having a shape matching that of the central body portion 131, 231 of the jaws 130, 230. The housing seats 32, 33 of the nuts are also defined by cylindrical surface portions. The surfaces of the seats 32, 33 for the nuts 22, 23 are oriented with concavity opposite the surface of the housing seat 31 for the upper jaw 130. In the assembled configuration of the seat post 10, the seat 31 of the flange 30 couples in abutment to the central body portion of the upper jaw 130, the seat 32 is arranged between the coupling portions 132′ and 133′ of the same upper jaw 130 and the seat 33 is arranged between the coupling portions 132″ and 133″ of the same jaw.

On each seat 32, 33 for the nuts 22, 23 a slot 34 is formed through which passes the respective clamping screw 20, 21 to screw into the respective nut 22, 23.

In the clamping step, by acting on the screws 20, 21, the flange 30 is pulled towards the tubular element 11 and the jaws 130 and 230 are clamped against each other locking the seat 2 in position with respect to the tubular element 11.

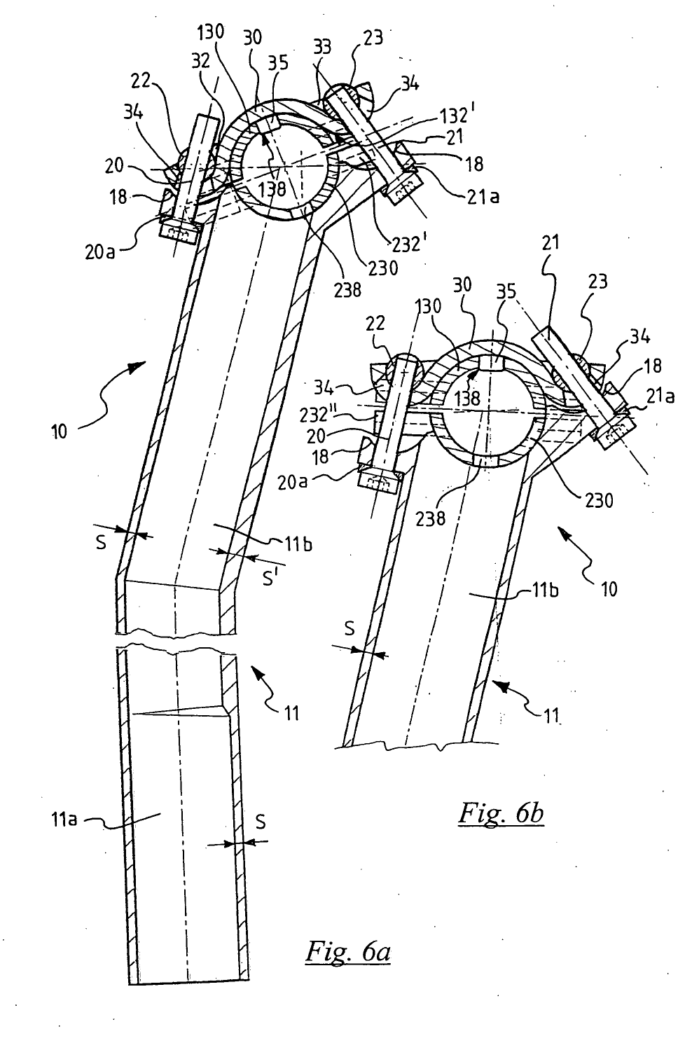

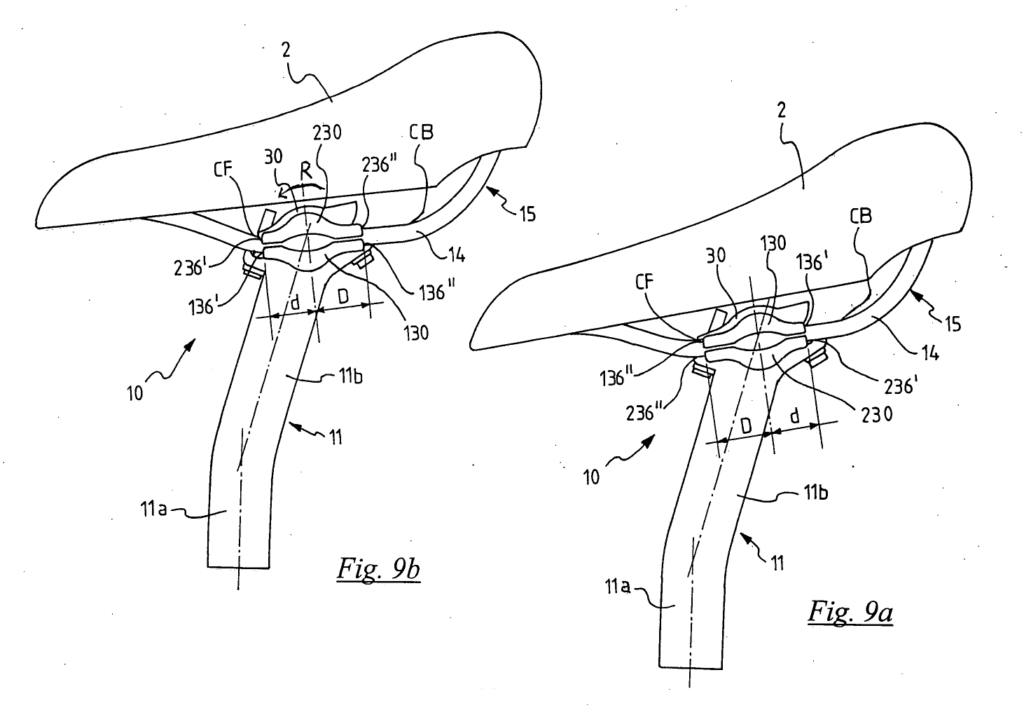

With particular reference to FIG. 3 and to FIGS. 6a, 6b, 9a, 9b, the central body portion 131 of the upper jaw 131 has a central hole 138 in which a small tooth 35 formed centrally in the seat 31 of the flange 30 can be inserted. The coupling of the small tooth 35 in the hole 138 allows the flange 30 to be pulled into rotation by the upper jaw 130, as shall be described more clearly hereafter.

In the embodiment of the seat post 10 illustrated in FIGS. 2-5, 6a, 6b, 7a, 7b, 8a, 8b, 9a, 9b, the interface surfaces between the jaws 130, 230 and the seats 17 and 31 all have the same diameter, so that the upper jaw 130 and the lower jaw 230 can be exchanged and/or rotated in a mirror-like way about an axis perpendicular to the axes of longitudinal symmetry S-S and S′-S′ of the respective central body portions 131, 231. In order to promote such an exchange and/or rotation, the jaws 130, 230 are made identical to each other.

The central body portion 231 of the lower jaw 230 is adapted to rotate in the seat 17 of the flange 16 of the tubular element 11 about the axis S′-S′. When the rods 15 are inserted in the grooves 134′, 134″, 235′, 235″, the lower jaw 230, rotating, pulls the upper jaw 130 into rotation with it which in turn, by means of the small tooth 35, pulls in rotation the flange 30. The flange 30 and the jaws 130, 230 are thus integral in rotation and can be locked in a predetermined angular position through the screws 20, 21.

In particular, by screwing one screw and unscrewing the other it is possible to rotate the jaws 130, 230 with respect to the tubular element 11 up to a desired angular position. FIGS. 6a, 6b show two extreme angular positions of the jaws 130, 230, in which the outer surfaces of the seats 32, 34 of the flange 30 are in abutment in a first case on one of the tabs 18 of the flange 16 of the tubular element 11 (the tab on the left in FIG. 6a) and in the other case on the other tab 18 (the tab on the right in FIG. 6b).

In an alternative embodiment that has not been illustrated, the pulling into rotation of the flange 30 by the upper jaw 130 is not achieved through the coupling between small tooth 35 and hole 138, but rather by providing appropriate knurlings on the outer surface of the central body portion 131 of the upper jaw 130 and on the inner surface of the seat 31 of the flange 30.

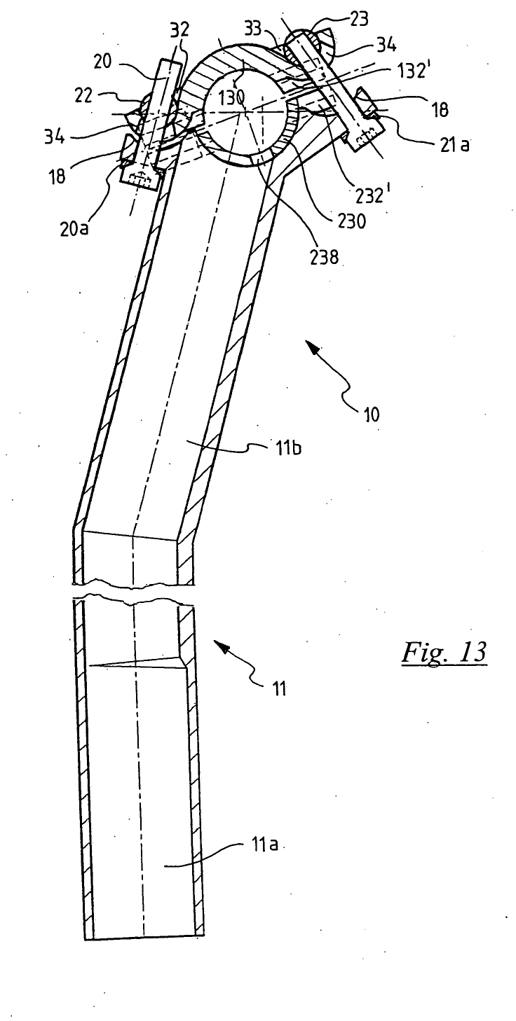

In an embodiment alternative to the one described above, illustrated in FIG. 13, the flange 30, instead of being made in a single piece distinct from the upper jaw 130, is made in a single piece with the latter. The upper jaw 130 is thus shaped so as to comprise side portions that define the seats 32, 33 for the nuts 22, 23. On such side portions the slots 34 for the passage of the screws 20, 21 are formed.

With particular reference to FIGS. 2, 3, 4, 5, the opposite front end surfaces of the grasping portions 132′, 132″ of the upper jaw 130 define abutment surfaces 136′, 136″ against which the front bending points CF and rear bending points CB of one of the rods 15 of the frame of the seat 2 abut, during the adjustment of the position of the seat 2 in the horizontal direction. The grasping portions 133′, 133″ of the upper jaw 130 have similar abutment surfaces 137′ and 137″ (FIG. 2).

As shown in FIGS. 4 and 5, the abutment surfaces 136′ and 137′ have the same distance d from the plane of symmetry of the central body portion 131 of the upper jaw 130 passing through the longitudinal axis S-S. Similarly, the abutment surfaces 136″ and 137″ have the same distance D, the distance D being greater than the distance d of the abutment surface 136′, 137′.

The upper jaw 130 is therefore asymmetric with respect to the plane of symmetry of the respective central body portion 131 passing through the axis S-S, with the coupling portions 132′, 133′ extending from the central body portion 131 asymmetrically with respect to the coupling portions 132″, 133″.

In the embodiment of the seat post 10 illustrated in FIGS. 2-5, 6a, 6b, 7a, 7b, 8a, 8b, 9a, 9b, the jaws 130, 230 are specular with respect to each other. Therefore, similarly to the upper jaw 130, also the lower jaw 230 comprises opposite abutment surfaces 236′, 236″ on the grasping portions 232′, 232″ and opposite abutment surfaces 237′, 237″ on the grasping portions 233′, 233″. The lower jaw 230 also comprises, similarly to the upper jaw 130, a hole 238 formed centrally on the central body portion 231 and adapted to receive the small tooth 35 of the flange 30 when the position of the lower and upper jaws 230 and 130 is inverted.

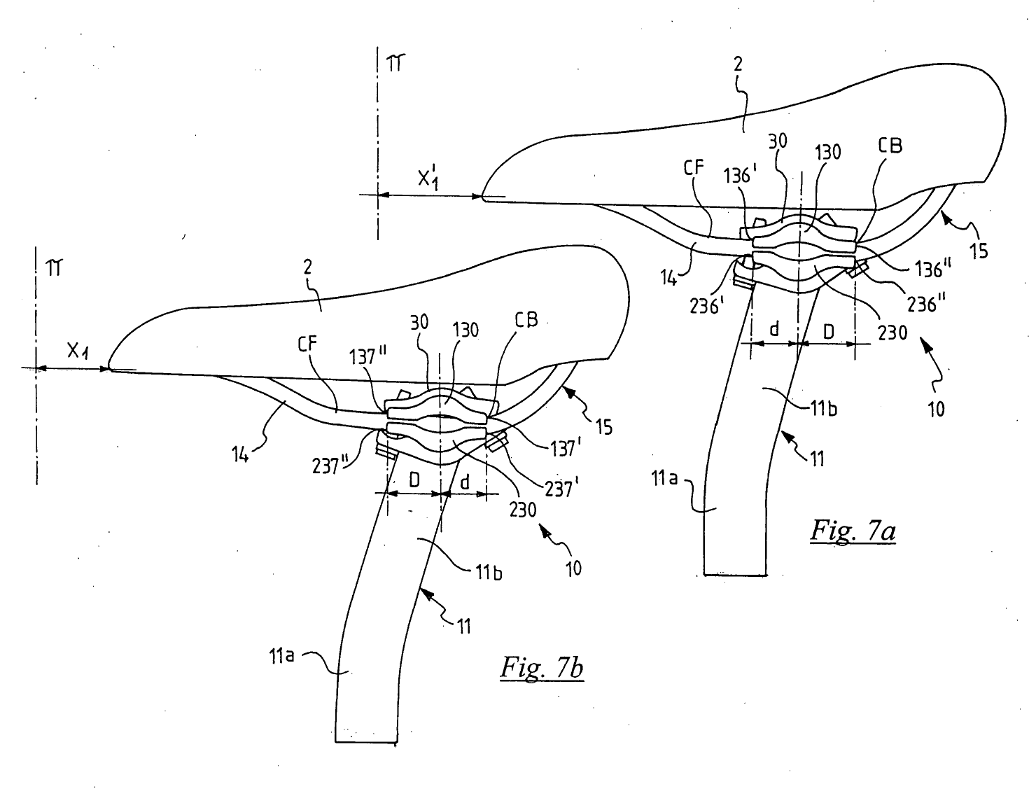

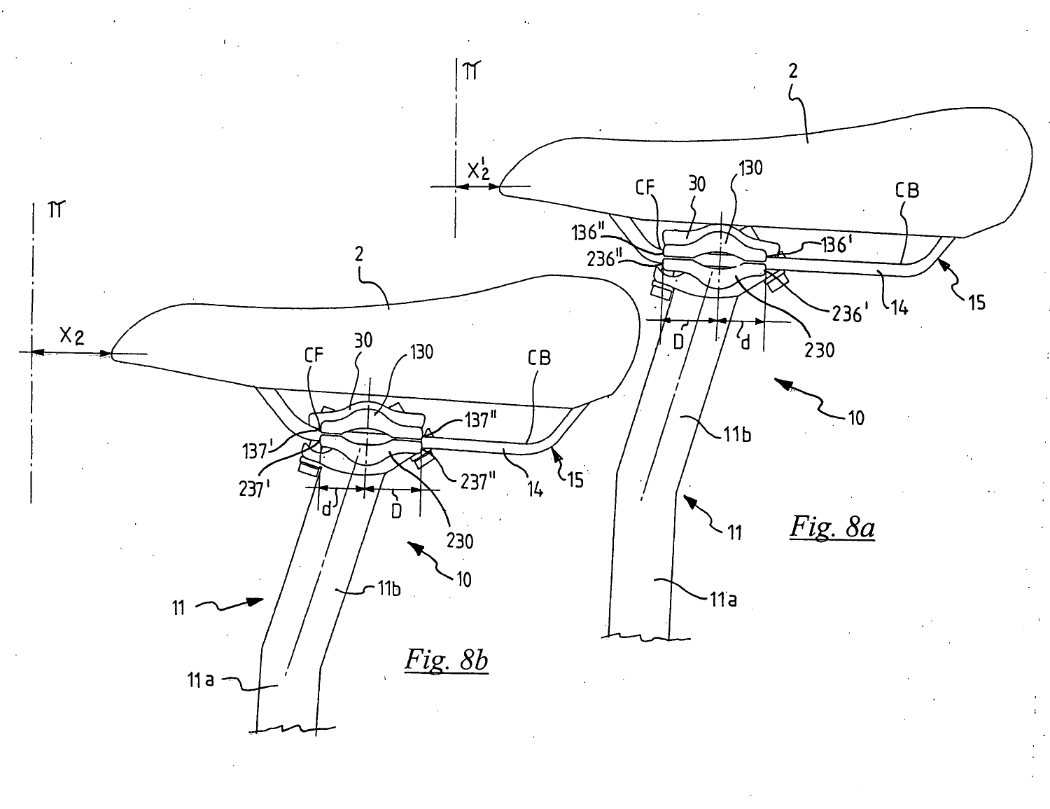

The use of the seat post 10 to adjust the position of the seat 2 along the horizontal direction is described with reference to FIGS. 7a, 7b and 8a, 8b.

Starting from an operative coupling configuration of the jaws 130, 230 to the seat 2 like that illustrated in FIG. 7a, assume that one wishes to proceed to adjust the position of the seat 2 with respect to the vertical plane π passing through the axis of the bottom bracket of the bicycle so as to bring the seat 2 even closer to such a plane.

As illustrated in FIG. 7a, the jaws 130, 230 are initially positioned with the abutment surfaces 136″, 137″, 236″, 237″ oriented in the direction of the back of the bicycle (on the right of FIG. 7a, where only the surfaces 136″ and 236″ can be seen). Such abutment surfaces are at a distance D from the planes of symmetry of the respective central body portions 131, 132 of the jaws 130, 230 passing through the longitudinal axes S-S and S′-S′.

In particular, in FIG. 7a the seat 2 is in a position in which the abutment surfaces 136″, 137″ of the upper jaw 130 are in abutment against the rear bending point CB of the seat rods 15. The distance of the seat 2 from the plane π is indicated with X1′ and, in a conventional seat post, this would be the maximum advanced position of the seat 2.

Let us now presume that one wishes to position the seat 2 even further towards the plane π. This is possible, according to the invention, by dismounting the flange 30 and rotating the jaws 130, 230 by 180° about an axis perpendicular to the axes of symmetry S-S and S′-S′ and lying on the plane of symmetry of the central body portions 131, 231 of the jaws 130, 230. One then passes from the operative coupling configuration of FIG. 7a to the operative coupling configuration of FIG. 7b. In this operative coupling configuration, the abutment surfaces 136′, 137′, 236′, 237′ are oriented in the direction of the back of the bicycle (in FIG. 7b only the surfaces 137′ and 237′ can be seen). As an alternative to the mirroring rotation of the jaws 130, 230, it is possible to pass from the first operative coupling configuration of FIG. 7a to the second operative coupling configuration of FIG. 7b by rotating the assembly of the jaws 130, 230 by 180° about an axis parallel to the longitudinal axes of the central body portions 131, 231 of the jaws 130, 230, i.e. exchanging the position of the two jaws.

Due to the fact that the abutment surfaces 136′, 137′, 236′, 237′ are at a distance d from the planes of symmetry of the respective central body portions 131, 132 of the jaws 130, 230 passing through the longitudinal axes S-S and S′-S′ smaller than the distance D at which the abutment surfaces 136″, 137″, 236″, 237″ are located, the seat 2 can be brought closer to the plane π and positioned at a distance X1 from such a plane π smaller than the distance X1′. Compared to a conventional seat post, the seat post of the present invention thus allows an additional adjustment stroke towards the plane π equal to D-d to be carried out. The distance X1 shall thus be:
X1=X1′−(D−d).

FIGS. 8a, 8b illustrate the process for adjusting the position of the seat 2 through the seat post 10 of the present invention in the case in which the seat 2 is in the maximum withdrawn position from the vertical plane π passing through the axis of the bottom bracket of the bicycle.

Starting from an operative coupling configuration of the jaws 130, 230 to the seat 2 like the one illustrated in FIG. 8a and assume that one proceeds to adjust the position of the seat 2 with respect to the plane π so as to take the seat 2 further away from such a plane without varying its angular position (i.e. keeping the jaws 130, 230 in the illustrated angular position).

As illustrated in FIG. 8a, the jaws 130, 230 are initially positioned with the abutment surfaces 136″, 137″, 236″, 237″ oriented towards the handlebars of the bicycle (to the left of FIG. 8a, where only the surfaces 136″ and 236″ can be seen).

In particular, in FIG. 8a the seat 2 is in a position in which the abutment surfaces 136″, 137″ of the upper jaw 130 abut against the front bending point CF of the rods 15 of the seat 2. The distance of the seat 2 from the plane π is indicated with X2′ and, in a conventional seat post, this would be the maximum withdrawn position of the seat 2.

Assume that one wishes to position the seat 2 even further back, i.e. even further from the plane π. Similarly to what was described with reference to FIGS. 7a, 7b, this is possible by dismounting the flange 30 and rotating mirror-like the jaws 130, 230 by 180° about an axis perpendicular to the axes of symmetry S-S and S′-S′ and lying on the plane of symmetry of the central body portions 131, 231 of the jaws 130, 230. One thus passes from the operative coupling configuration of FIG. 8a to the operative coupling configuration of FIG. 8b. In this operative coupling configuration, the abutment surfaces 136′, 137′, 236′, 237′ are oriented towards the handlebars of the bicycle (in FIG. 8b only the surfaces 137′ and 237′ can be seen). Also in this case, as an alternative to the mirror-like rotation of the jaws 130, 230, it is possible to pass from the first operative coupling configuration of FIG. 8a to the second operative coupling configuration of FIG. 8b by rotating the assembly of the jaws 130,230 by 180° about an axis parallel to the longitudinal axes of the central body portions 131, 231 of the jaws 130, 230, i.e. exchanging the position of the two jaws.

The seat 2 can thus be taken away from the plane π and positioned at a distance X2 from the plane n greater than the distance X2′. Compared to a conventional seat post, the seat post of the present invention thus allows an additional adjustment stroke away from the plane π equal to D-d to be carried out. The distance X2 shall thus be:
X2=X2′+(D−d).

FIGS. 9a, 9b illustrate the same process for adjusting the position of the seat 2 described with reference to FIGS. 8a, 8b; in FIGS. 9a, 9b, however, the seat 2 is in a different angular position (see also the different angular position of the jaws 130, 230). Moreover, as an alternative to the mirror-like rotation described above with respect to FIGS. 8a, 8b, in the adjustment process illustrated in FIGS. 9a, 9b the jaws 130, 230 are exchanged, in the sense that the upper jaw 130 is positioned in the place of the lower jaw 230 and vice-versa. The exchange of the jaws can be carried out by rotating the assembly formed by the two jaws by 180° about an axis parallel to the longitudinal axes S-S and S′-S′ of the central bodies 131, 231 of the jaws 130, 230, as indicated by the arrow R in FIG. 9b.

In the embodiment of the seat post 10 illustrated in FIGS. 2-5, 6a, 6b, 7a, 7b, 8a, 8b, 9a, 9b, the upper and lower jaws 130 and 230 are asymmetric and specular. The upper jaw 130 is, in other words, asymmetric with respect to the plane of symmetry of the respective central body portion 131 passing through the axis S-S, with the coupling portions 132′, 133′ extending from the central body portion 131 asymmetrically with respect to the coupling portions 132″, 133″. Similarly, the lower jaw 230 is asymmetric with respect to the plane of symmetry of the respective central body portion 231 passing through the axis S′-S′, with the coupling portions 232′, 233′ extending from the central body portion 231 asymmetrically with respect to the coupling portions 232″, 233″.

Nevertheless, embodiments (not illustrated) are foreseen in which the grasping portions extend cantilevered from just one side of the central body portions of the jaws. In particular, in these embodiments, in the jaws 130, 230 the coupling portions 132′, 133′ and 232′, 233′ are not present and the abutment surfaces 136′, 137′ and 236′, 237′ shall be formed directly on the central body portions 131, 231 of the jaws 130, 230, on the opposite side to that from which the grasping portions 132″, 133″ and 232″, 233″ extend.

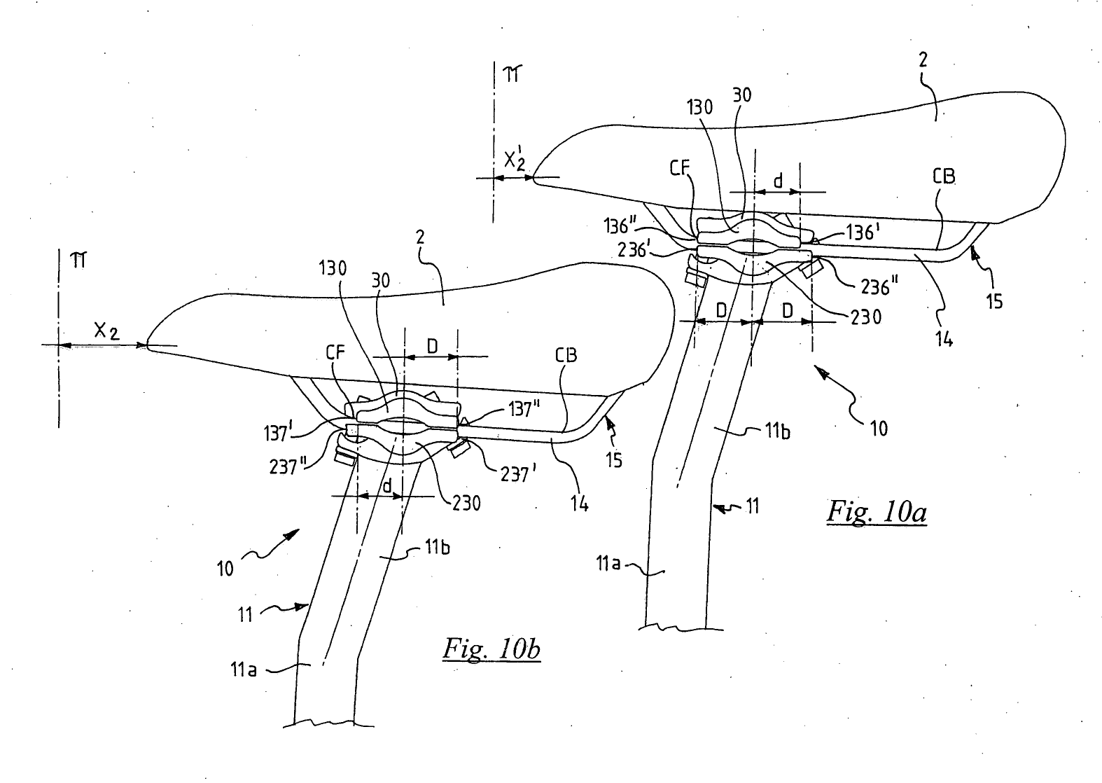

FIGS. 10a and 10b illustrate the same process for adjusting the position of the seat 2 described with reference to FIGS. 8a, 8b for an embodiment of the seat post 10 that differs from the one illustrated and described previously only for the fact that it comprises a symmetric lower jaw 230. The upper and lower jaw 130 and 230 are thus different; in particular the upper jaw 130 is asymmetric and identical to the one described previously, whereas the lower jaw 230 is symmetrical and longer than the upper jaw 130.

More specifically, the distance D of the abutment surfaces 236′ and 237′ from the plane of symmetry of the central body portion 231 of the lower jaw 230 passing through the longitudinal axis S′-S′ is equal to that of the abutment surfaces 136″ and 137″ of the upper jaw 130 from the plane of symmetry of the central body portion 131 of the upper jaw 130 passing through the longitudinal axis S-S. The abutment surfaces 236″ and 237″ of the lower jaw 230 have a distance from the plane passing through the axis S′-S′ equal to the distance of the abutment surfaces 236′, 237′ from the same plane.

FIGS. 10a and 10b show a possible sequence of use in which both of the jaws 130, 230 are rotated by 180° about an axis perpendicular to the axes of symmetry S-S and S′-S′ and lying on the plane of symmetry of the central body portions 131, 231 of the jaws 130, 230. The upper jaw 130 provides the seat 2 with a reference abutment in the horizontal direction, whereas the lower jaw 230 provides a support for the zone of the seat 2 in which the weight of the cyclist is discharged greater than in the case described with reference to FIGS. 2-5, 6a, 6b, 7a, 7b, 8a, 8b, 9a, 9b.

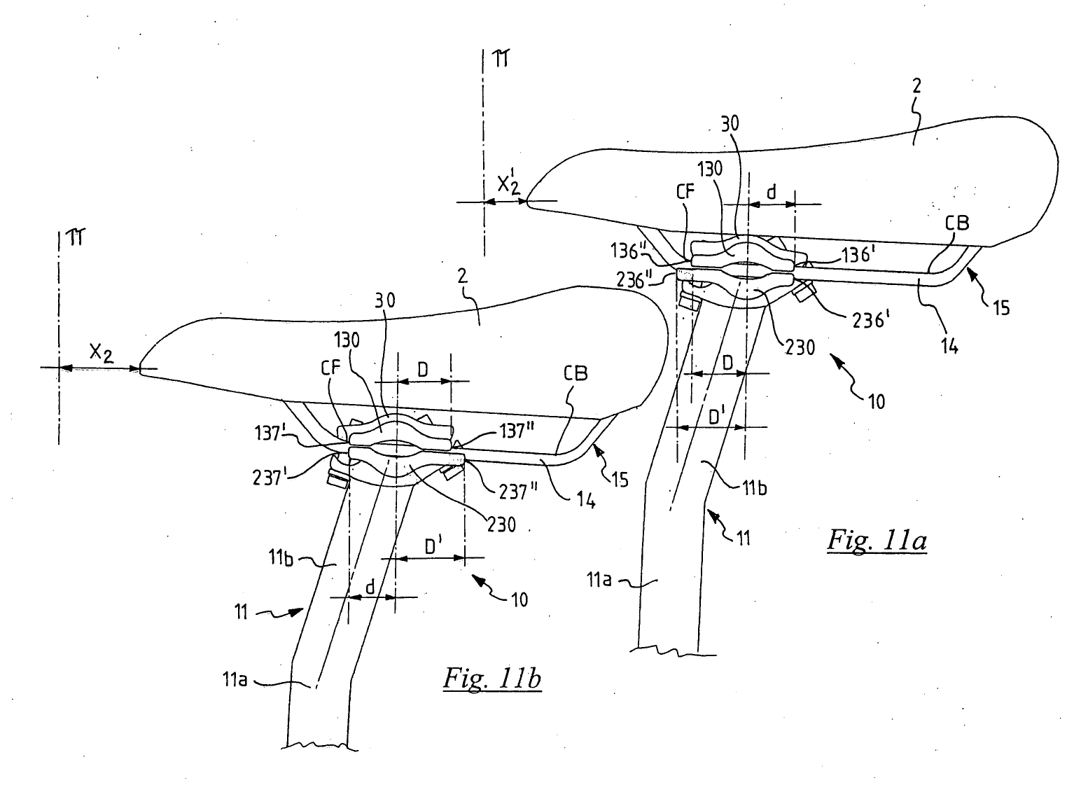

FIGS. 11a and 11b illustrate the same process for adjusting the position of the seat 2 described with reference to FIGS. 8a, 8b for a seat post 10 that differs from the one illustrated and described previously for the only reason that it comprises a lower jaw 230 that is asymmetric and of greater length than the upper jaw 130. The upper and lower jaw 130 and 230 are thus different; in particular the upper jaw 130 is asymmetric and identical to the one described previously, whereas the lower jaw 230 is asymmetric and longer than the upper jaw 130.

More specifically, the distance d of the abutment surfaces 236′ and 237′ from the plane of symmetry of the central body portion 231 of the lower jaw 230 passing through the longitudinal axis S′-S′ is equal to that of the abutment surfaces 136′ and 137′ of the upper jaw 130 from the plane of symmetry of the central body portion 131 of the upper jaw 130 passing through the longitudinal axis S-S. The abutment surfaces 236″ and 237″ of the lower jaw 230, on the other hand, are at a distance D′ from the plane passing through the axis S′-S′ greater than the distance d of the abutment surface 236′, 237′ from the same plane and than the distance D of the abutment surfaces 136″, 137″ of the upper jaw 130 from the plane passing through the axis S-S.

FIGS. 11a and 11b show a possible sequence of use in which both of the jaws 130, 230 are rotated by 180° about an axis perpendicular to the axes of symmetry S-S and S′-S′ and lying on the plane of symmetry of the central body portions 131, 231 of the jaws 130, 230. The upper jaw 130 provides the seat 2 with a reference abutment in the horizontal direction, whereas the lower jaw 230 provides a support for the zone of the seat 2 in which the weight of the cyclist is discharged greater than in the case described with reference to FIGS. 2-5, 6a, 6b, 7a, 7b, 8a, 8b, 9a, 9b, 10a, 10b.

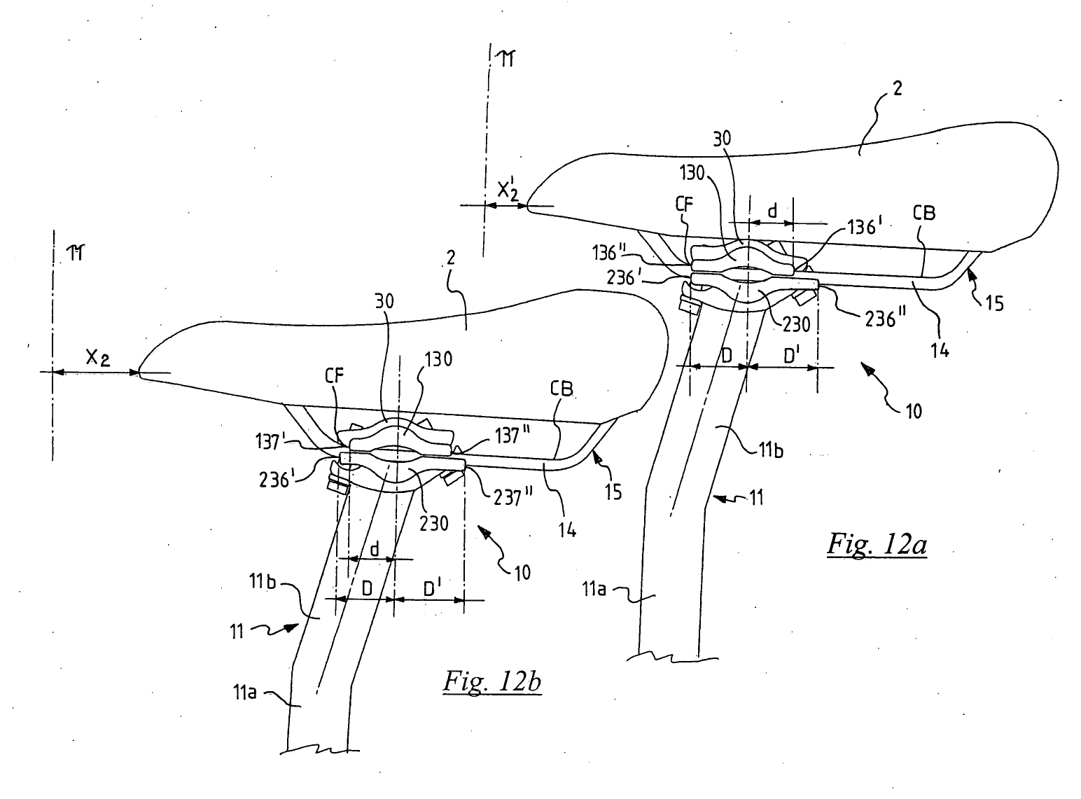

FIGS. 12a and 12b illustrate a seat post 10 that differs from the one illustrated in FIGS. 11a, 11b for the only reason that in the lower jaw 230 the distance D of the abutment surfaces 236′ and 237′ from the plane of symmetry of the central body portion 231 of the lower jaw 230 passing through the longitudinal axis S′-S′ is equal to that of the abutment surfaces 136″ and 137″ of the upper jaw 130 from the plane of symmetry of the central body portion 131 of the upper jaw 130 passing through the longitudinal axis S-S. The abutment surfaces 236″ and 237″ of the lower jaw 230, on the other hand, are at a distance D′ from the plane passing through the axis S′-S′ greater than the distance D of the abutment surface 236′, 237′ from the same plane.

FIGS. 12a and 12b show a possible sequence of use in which only the upper jaw 130 is rotated by 180° about an axis perpendicular to the axis of symmetry S-S and lying on the plane of symmetry of the central body portion 131 of the jaw 130. The upper jaw 130 provides the seat 2 with a reference abutment in the horizontal direction, whereas the lower jaw 230, already being located in the position in which it provides the maximum support to the zone of the seat 2 in which the weight of the cyclist is discharged, is not moved.

In all of the embodiments discussed above, the jaws can be shaped so that the aforementioned abutment surfaces 136′, 136″, 137′, 137″, 236′, 236″, 237′, 237″ are curved, with a concavity facing towards the outside of the seat post 10. Such a provision allows a further additional adjustment stroke to be obtained, in addition to the one obtained with the asymmetry of the upper jaw 130 (and possibly the lower jaw 230).

FIG. 6a shows an embodiment of the seat post of the present invention in which the portion 11b of the tubular element 11 of the seat post 10 has an asymmetric section along its entire longitudinal extension with an increased thickness S′ at the side intended to face towards the back of the bicycle. The side of the portion 11b of the tubular element 11 intended to face towards the handlebars of the bicycle has a thickness S smaller than the thickness S′. A first part of the portion 11a of the tubular element 11 adjacent to the portion 11b has an asymmetric section with increased thickness S′. Such a first part is adapted to remain outside the tubular seat 12 provided in the frame 3 of the bicycle. The lower part of the portion 11a, on the other hand, has a symmetric section with a thickness S equal to that of the side of the portion 11b of the tubular element 11 intended to face towards the handlebars of the bicycle. Such a lower part is intended to be telescopically inserted into the tubular seat 12 provided in the frame 3 of the bicycle.

FIG. 6b shows an alternative embodiment of the seat post of the present invention in which the portion 11b of the tubular element 11 has a symmetric cross section of thickness S along the entire longitudinal extension thereof.

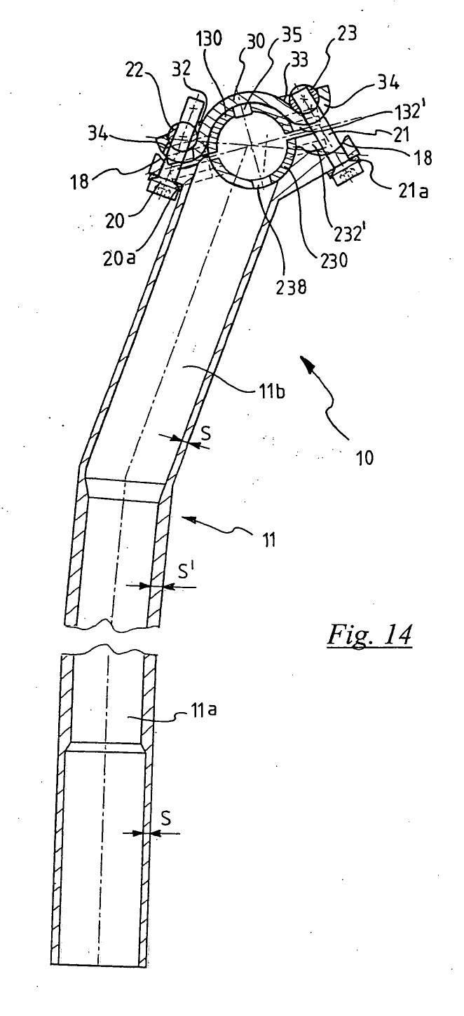

FIG. 14 shows an embodiment of the seat post of the present invention in which the portion 11b of the tubular element 11 has a symmetric cross section with a thickness S, like in FIG. 6b, and in which a first part of the portion 11a of the tubular element 11 adjacent to the portion 11b has a symmetric section with increased thickness S′, whereas the lower part of the portion 11a has a symmetric section with a thickness S. Also in this case, the increased thickness is provided in the part of the tubular element 11 that remains outside the tubular seat 12 provided in the frame 3 of the bicycle.

FIG. 15 shows a further embodiment of the tubular element 11 of the seat post 10 of the present invention. In such an embodiment, the portion 11b and a first part of the portion 11a of the tubular element 11 have an asymmetric cross section with increased thickness S′ at the side intended to face towards the back of the bicycle. The lower part of such a first part of the portion 11a is intended to be telescopically inserted into the tubular seat 12 provided in the frame 3 of the bicycle. The part further lower of the portion 11a, instead has a symmetric section with constant thickness S which is the same as that of the side of the portion 11b of the tubular element 11 intended to face towards the handlebars of the bicycle.

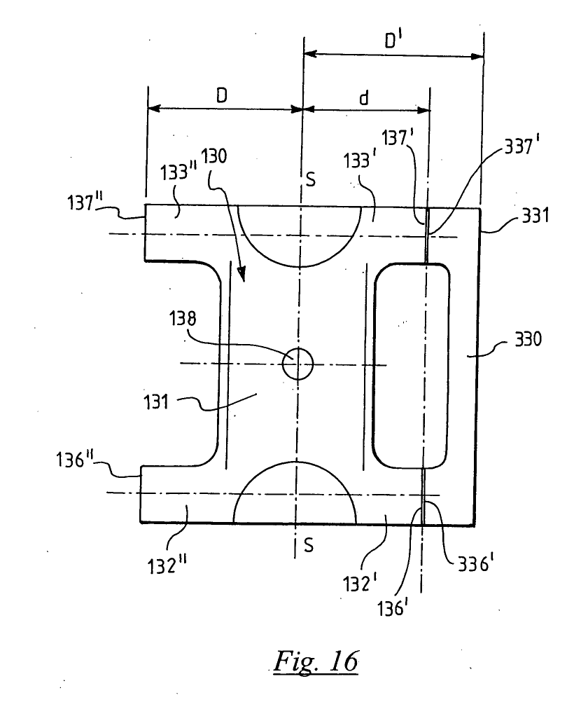

FIG. 16 shows an alternative embodiment of the upper jaw 130 (and possibly the lower jaw 230) of the seat post 10 of the present invention. Such an embodiment differs from the one described previously for the only reason that it comprises a removable abutment element 330 associated, for example by a joint, for example a dovetailing joint, with the upper jaw 130 at the abutment surfaces 136′, 137′. The abutment element 330 comprises coupling surfaces 336′, 337′ to the jaw 130 and an opposite abutment surface 331. When coupled with the jaw 130, the abutment surface 331 is at a distance D′ from the axis S-S greater than the distance d of the abutment surfaces 136′, 137′.

In such an embodiment, the abutment element 330 can be removed from the jaw 130 so that the latter provides the abutment surfaces 136′, 137′ for the abutment, obtaining an additional adjustment stroke, as described above. Of course, it is possible to foresee a plurality of abutment elements 330 that can be removably coupled together and removed individually to obtain different additional adjustment strokes.

The seat post 10 of the present invention can be made from light metal alloys or also from composite material. The composite material can comprise structural fibers incorporated in a polymeric material.

Typically, the structural fibers are chosen from the group comprising carbon fibers, glass fibers, aramidic fibers, ceramic fibers, boron fibers and combinations thereof. Carbon fibers are particularly preferred.

The arrangement of the structural fibers in the polymeric material can be a random arrangement of pieces or small sheets of structural fibers, an ordered substantially unidirectional arrangement of fibers, an ordered substantially two-dimensional arrangement of fibers, or a combination of the above.

Preferably, the polymeric material is thermosetting. However it is possible to use a thermoplastic material.

More preferably, the polymeric material comprises an epoxy resin.

The tubular element 11, the jaws 130, 230 and the flange 30 can be made from the same material.

In the embodiments in which the flange 30 is made in a different piece to the upper jaw 130, the jaws can, for example, be made from composite material and the flange 30 can be made from light metal alloy.

In a preferred embodiment of the seat post 10 of the present invention, the tubular element 11 is made from carbon fiber whereas the flange 30 and the jaws 130, 230 are made from light metal alloy.

What is claimed is:

1. Seat post for a bicycle, comprising:
a tubular element configured to support a seat of a bicycle; and
grasping means of a portion of a frame of said seat configured to be coupled to said tubular element and to be selectively activated/deactivated to prevent/allow a translation movement of the seat with respect to said tubular element along a predetermined direction, said grasping means comprising at least one first abutment element and being configured to be coupled to said tubular element in a first operative coupling configuration in which said at least one first abutment element defines a first translation limit position of the seat with respect to the tubular element in a first way of said predetermined direction;
wherein said grasping means further comprise at least one second abutment element which defines at least one second translation limit position of the seat with respect to the tubular element in said first way of said predetermined direction, said at least one second translation limit position being translated with respect to said first translation limit position along said first way of said predetermined direction.

2. Seat post according to claim 1, wherein said at least one first abutment element is configured to be removably associated with said at least one second abutment element.

3. Seat post according to claim 2, wherein said at least one first abutment element can be associated by a joint with said at least one second abutment element.

4. Seat post according to claim 1, wherein said at least one first abutment element is made integrally with said at least one second abutment element and wherein said at least one second abutment element defines said at least one second translation limit position of the seat in at least one second operative coupling configuration of said grasping means with said tubular element.

5. Seat post according to claim 4, wherein in said first operative coupling configuration said at least one second abutment element defines a translation limit position of the seat with respect to the tubular element in a second way of said predetermined direction opposite said first way.

6. Seat post according to claim 5, wherein said grasping means further comprises:
a coupling portion configured to couple with said tubular element; and
at least one grasping portion configured for engagement with said portion of seat extending cantilevered asymmetrically from, and substantially perpendicular to, said coupling portion,
wherein said at least one first abutment element is defined by a first end surface of said at least one grasping portion.

7. Seat post according to claim 6, wherein said at least one grasping portion extends cantilevered from only one side of said coupling portion and said at least one second abutment element is defined on said coupling portion on the opposite side to that from which said at least one grasping portion extends.

8. Seat post according to claim 6, wherein said at least one grasping portion extends cantilevered asymmetrically from opposite sides of said coupling portion and said at least one second abutment element is defined by at least one second end surface of said at least one grasping portion arranged at the opposite side to said first end surface with respect to said coupling portion.

9. Seat post according to claim 8, wherein said at least one second abutment surface is arranged, with respect to said coupling portion, at a distance shorter than the distance between said first abutment surface and said coupling portion.

10. Seat post according to claim 6, wherein said grasping means further comprise a pair of jaws configured to be coupled together through clamping means, said at least one first and at least one second abutment element being defined in an upper jaw of said pair of jaws.

11. Seat post according to claim 10, wherein the jaws of said pair of jaws can be rotatably associated with said tubular element with respect to an axis perpendicular to a longitudinal plane of symmetry of a frame of said bicycle.

12. Seat post according to claim 10, wherein said coupling portion of said grasping means is defined in a central body portion of both of the jaws of said pair of jaws.

13. Seat post according to claim 12, wherein said central body portion comprises a cylindrical surface portion extending along a respective longitudinal axis.

14. Seat post according to claim 8, wherein said at least one grasping portion comprises:
a first pair of grasping surfaces of said portion of seat, the grasping surfaces of said first pair of grasping surfaces extending parallel to each other at opposite free ends of the central body portion of a first jaw of said pair of jaws; and
a second pair of grasping surfaces of said portion of seat, the grasping surfaces of said second pair of grasping surfaces extending parallel to each other at opposite free ends of the central body portion of a second jaw of said pair of jaws.

15. Seat post according to claim 14, wherein said first and at least one second abutment surface are defined in an upper jaw of said pair of jaws, at opposite front end surfaces of said grasping surfaces.

16. Seat post according to claim 10, wherein the jaws of said pair of jaws are specular.

17. Seat post according to claim 11, wherein said first and at least one second abutment surface are defined in said first jaw of said pair of jaws and the grasping surfaces of said first pair of grasping surfaces extend asymmetrically with respect to said longitudinal axis for a first portion of predetermined length.

18. Seat post according to claim 17, wherein the grasping surfaces of said second pair of grasping surfaces extend on said second jaw symmetrically with respect to said longitudinal axis for a second portion of length greater than said first portion of predetermined length.

19. Seat post according to claim 17, wherein the grasping surfaces of said second pair of grasping surfaces extend on said second jaw asymmetrically with respect to said longitudinal axis for a second portion of greater length than said first portion of predetermined length.

20. Seat post according to claim 1, wherein said first and at least one second abutment element are defined by curved surfaces having a concavity facing outwards.

21. Seat post according to claim 1, wherein said tubular element comprises a first rectilinear body portion configured to be at least in part telescopically inserted in a tubular housing seat formed in a frame of the bicycle and a second body portion inclined with respect to said first body portion, said second body portion comprising a coupling free end to said grasping means.

22. Seat post according to claim 21, wherein said second body portion of said tubular element further comprises, at said free coupling end, a first flange made integrally with said second body portion and comprising a housing seat of said coupling portion of said grasping means.

23. Seat post according to claim 22, wherein said first flange further comprises, at opposite sides to said housing seat, a pair of tabs extending cantilevered from said housing seat and defining angular limit positions of said grasping means.

24. Seat post according to claim 23, wherein the tabs of said pair of tabs are arranged at different heights.

25. Seat post according to claim 23, wherein said clamping means comprise a pair of screws and respective nuts, said screws being configured to pass in respective through holes formed on said first flange at said tabs and in respective slots formed on said grasping means on opposite sides to said coupling portion to fix said grasping means in position with respect to said tubular element.

26. Seat post according to claim 25, wherein said grasping means further comprise a second flange configured to be coupled with said first flange through said clamping means, in which said slots are formed in said second flange.

27. Seat post according to claim 26, wherein said second flange is made in a distinct piece from the jaws of said pair of jaws.

28. Seat post according to claim 26, wherein at least one jaw of said pair of jaws comprises means for pulling said second flange in rotation.

29. Seat post according to claim 28, wherein said pulling means comprise a small tooth formed on said second flange and a corresponding coupling hole formed on said at least one jaw.

30. Seat post according to claim 26, wherein said second flange is made in a single piece with a jaw of said pair of jaws.

31. Seat post according to claim 21, wherein said tubular element has, for at least part of the longitudinal extension thereof, an asymmetric cross section.

32. Seat post according to claim 31, wherein said asymmetric cross section comprises said second body portion and said first body portion adjacent to said second body portion.

33. Seat post according to claim 21, wherein said tubular element has a symmetric cross section for the entire longitudinal extension thereof.

34. Seat post according to claim 33, wherein said tubular element has a zone of increased thickness at a first part of said first body portion adjacent to said second body portion.

35. Seat post according to claim 1, wherein said tubular element is made from a light metal alloy.

36. Seat post according to claim 1, wherein said tubular element is made from composite material.

37. Seat post according to claim 10, wherein said jaws are made from the same material as that from which said tubular element is made.

38. Seat post for a bicycle, comprising:
a tubular element configured to support a seat of a bicycle; and
a grasping apparatus for grasping a portion of a frame of said seat configured to be coupled to said tubular element and to selectively allow a translation movement of said seat with respect to said tubular element along a predetermined direction, said grasping apparatus comprising:
at least one first abutment element configured to be coupled to said tubular element in a first operative coupling configuration in which said at least one first abutment element defines a first translation limit position of said seat with respect to said tubular element in a first way of said predetermined direction;
at least one second abutment element which defines at least one second translation limit position of said seat with respect to said tubular element in said first way of said predetermined direction, said at least one second translation limit position being translated with respect to said first translation limit position along said first way of said predetermined direction;
a coupling portion configured to couple with said tubular element;
at least one grasping portion configured for engagement with said portion of said seat; and
a pair of jaws configured to be coupled together through a clamping device, said at least one first and at least one second abutment element being defined in an upper jaw of said pair of jaws;
wherein said at least one first abutment element is made integrally with said at least one second abutment element and wherein said at least one second abutment element defines said at least one second translation limit position of said seat in at least one second operative coupling configuration of said grasping apparatus with said tubular element;
in said first operative coupling configuration said at least one second abutment element defines a translation limit position of said seat with respect to said tubular element in a second way of said predetermined direction opposite said first way;
at a free coupling end of said tubular element a housing seat of said coupling portion of said grasping apparatus and a pair of tabs extending cantilevered from said housing seat and defining angular limit positions of said grasping apparatus are provided;
said clamping device comprises a pair of screws and respective nuts, said screws being configured to pass in respective through holes formed on said tabs and in respective slots formed on said grasping apparatus on opposite sides to said coupling portion to fix said grasping apparatus in position with respect to said tubular element;
said grasping apparatus further comprises a flange configured to be coupled with said tabs through said clamping device, in which said slots are formed in said; and
said flange is made in a single piece with a jaw of said pair of jaws.

39. Seat post for a bicycle, comprising:
a tubular element configured to support a seat of a bicycle; and
a grasping apparatus for grasping a portion of a frame of said seat configured to be coupled to said tubular element and to selectively allow a translation movement of the seat with respect to said tubular element along a predetermined direction, said grasping apparatus comprising:
at least one first abutment element and being configured to be coupled to said tubular element in a first operative coupling configuration in which said at least one first abutment element defines a first translation limit position of the seat with respect to the tubular element in a first way of said predetermined direction;
at least one second abutment element which defines at least one second translation limit position of the seat with respect to the tubular element in said first way of said predetermined direction, said at least one second translation limit position being translated with respect to said first translation limit position along said first way of said predetermined direction;
a coupling portion configured to couple with said tubular element; and
a pair of jaws configured to be coupled together through a clamping device;
wherein said tubular element comprises a first rectilinear body portion configured to be at least in part telescopically inserted in a tubular housing seat formed in a frame of the bicycle and a second body portion inclined with respect to said first body portion, said second body portion comprising a coupling free end to said grasping apparatus;
at said free coupling end of said second body portion a housing seat of said coupling portion of said grasping apparatus and a pair of tabs extending cantilevered from said housing seat and defining angular limit positions of said grasping apparatus are provided;
said clamping device comprises a pair of screws and respective nuts, said screws being configured to pass in respective through holes formed on said tabs and in respective slots formed on said grasping apparatus on opposite sides to said coupling portion to fix said grasping apparatus in position with respect to said tubular element;
said grasping apparatus further comprises a flange configured to be coupled with said tabs through said clamping device, in which said slots are formed in said flange; and
said flange is made in a single piece with a jaw of said pair of jaws.

40. Seat post for a bicycle, comprising:
a tubular element configured to support a seat of a bicycle; and
a grasping apparatus for grasping a portion of a frame of said seat configured to be coupled to said tubular element and to selectively allow a movement of the seat with respect to said tubular element along a predetermined direction, said grasping apparatus comprising:
a coupling portion configured to mate with said tubular element; and
a pair of jaws configured to be coupled together through a clamping device;
wherein said tubular element comprises a first rectilinear body portion configured to be at least in part telescopically inserted in a tubular housing seat formed in a frame of the bicycle and a second body portion inclined with respect to said first body portion, said second body portion comprising a coupling free end to said grasping apparatus;
said second body portion of said tubular element further comprises, at said free coupling end, a first flange integral with said second body portion and comprising a housing seat of said coupling portion of said grasping apparatus;
said grasping apparatus further comprises a second flange configured to be coupled with said first flange through said clamping device; and
said second flange is made in a single piece with a jaw of said pair of jaws.

41. Seat post for a bicycle, comprising:
a tubular element configured to support a seat of a bicycle; and
a grasping apparatus for grasping a portion of a frame of said seat configured to be coupled to said tubular element and to selectively allow a translation movement of the seat with respect to said tubular element along a predetermined direction, said grasping apparatus comprising at least one first abutment element and being configured to be coupled to said tubular element in a first operative coupling configuration in which said at least one first abutment element defines a first translation limit position of the seat with respect to the tubular element in a first way of said predetermined direction;
wherein said grasping apparatus further comprises:
at least one second abutment element which defines at least one second translation limit position of the seat with respect to the tubular element in said first way of said predetermined direction, said at least one second translation limit position being translated with respect to said first translation limit position along said first way of said predetermined direction;
a coupling portion configured to couple with said tubular element; and
at least one grasping portion configured for engagement with said portion of seat extending cantilevered asymmetrically from, and substantially perpendicular to, opposite sides of said coupling portion; wherein said at least one first abutment element is defined by a first end surface of said at least one grasping portion;
said at least one second abutment element is defined by at least one second end surface of said at least one grasping portion arranged at the opposite side to said first end surface with respect to said coupling portion; and
said grasping apparatus further comprises a pair of jaws that can be coupled together through a clamping device, said at least one first and at least one second abutment element being defined in an upper jaw of said pair of jaws.

42. A seat post for a bicycle, comprising:
a tubular element configured to support a seat of a bicycle; and
a grasping device that selectively allows translation movement of a bicycle seat with respect to said tubular element along a predetermined direction, said grasping device comprising:
at least one first abutment element defining a first translation limit position of the seat with respect to the tubular element in a first predetermined direction;
at least one second abutment element defining a second translation limit position of the seat with respect to the tubular element in said predetermined direction, said at least one second translation limit position being translated with respect to said first translation limit position along said first predetermined direction.

43. A bicycle seat post assembly comprising:
an elongated angled tubular element that terminates at an end thereof in a horizontally oriented concave seat base flanked by tabs that include defined apertures;
a pair of mating jaws, that define a tubular interior bicycle seat frame clamp between them and an exterior that nest within the concave seat base;
a flange having a convex central portion that complements the exterior of the mating jaw spaced away from the concave seat base and concave housing seats that include defined apertures that are positioned to align with the concave seat base apertures;
a pair of barrel nuts that are within the concave housing seats; and
a pair of elongated fasteners that pass through the apertures in the concave seat base and the flange apertures to engage the barrel nuts,
whereby loosening the fasteners enables movement of the nested mating jaw in the concave seat base and the location of a bicycle seat in a desired position and tightening of the fasteners draws the concave seat base and flange together and fixes the bicycle seat in the desired position.

44. The bicycle seat post assembly of claim 43, wherein at least the nested mating jaw includes extensions that pass along side the tabs.

45. The bicycle seat post assembly of claim 44, wherein the extensions are tubular channels for receiving rails of the bicycle seat.

46. The bicycle seat post assembly of claim 44, wherein the housing seats are inside the mating jaw extensions.

47. The bicycle seat post assembly of claim 43, wherein the mating jaws include extensions that pass along side the tabs.

47. The bicycle seat post assembly of claim 47, wherein the housing seats are inside the mating jaw extensions.

48. The bicycle seat post assembly of claim 43, wherein the housing seats are positioned over the tabs.

49. The bicycle seat post assembly of claim 43, wherein an upper jaw of the mating jaws comprises a central hole to receive a tooth formed centrally in seat of the flange, allowing the flange to be pulled into rotation by the upper jaw.
